(19) United States
(12) Patent Application Publication
(10) Pub. No.: US 2015/0070288 A1
(43) Pub. Date: Mar. 12, 2015

(54) METHOD AND APPARATUS FOR PROVIDING 3D INPUT

(71) Applicants: Wenjuan Song, Beijing (CN); Guanghua Zhou, Beijing (CN)

(72) Inventors: Wenjuan Song, Beijing (CN); Guanghua Zhou, Beijing (CN)

(73) Assignee: THOMSON LICENSING, Issy de Moulineaux (FR)

(21) Appl. No.: 14/395,484

(22) PCT Filed: Apr. 28, 2012
(86) PCT No.: PCT/CN2012/074877

§ 371 Date: Oct. 18, 2014

(51) Int. Cl. G06F 3/0346; G06F 3/041

(52) U.S. Cl. CPC G06F 3/0346; G06F 3/041
USPC 345/173

(57) ABSTRACT

There is provided a method for providing position information in a 3D coordinates system based on user's touch position on an input device. It comprises, at the side of the input device, steps of changing orientation of the input device to a first state; determining information about touch position in response to a user's touch; determining information about orientation change between the first state and a default state; wherein, the information about the touch position and the information about orientation change are used to determine the position information in the 3D coordinates system.

### TECHNICAL FIELD

The present invention relates to inputs, and more particularly relates to a method and an apparatus for providing 3D inputs.

### BACKGROUND

Although three-dimensional (“3D”) graphics or stereoscopic applications are increasingly used, the development of input devices for this particular domain evolves slowly. The desktop PC environment is still dominated by the mouse, and only a small variety of input devices is commercially available. For example, for Virtual Reality applications, tracked wands are commonly used.

Currently, almost everyone has a mobile phone, and many of them support touch screen or touchpad input. Normally, the touch screen or touchpad has a flat surface and is equipped with a tactile sensor or other kinds of sensors used for detecting the presence and location of a touch or touches on the flat surface, and translating the position of the touch to a relative position on the display screen. When a touching object, e.g. a finger or stylus, moves on the flat surface, the sensor can detect the motion of the touching object, and translate the motion into a relative motion on the display screen. However, the touch screen and touchpad only support two-dimensional (“2D”) touch input.

In 3D input field, a US patent application “US 2009/0184936 A1” named “3D touchpad” describes an input system which is comprised of three touch pads that are positioned to be parallel to the xy, yz and xz-plane, wherein moving the user's finger on the 3D touchpad provides six degrees-of-freedom (hereinafter referred to as 6DOF) to the computer system.

It is desired to use a single touch screen or touchpad to enable 3D inputs.

### SUMMARY

According to an aspect of present invention, there is provided a method for providing position information in a 3D coordinates system based on user's touch position on an input device. It comprises, at the side of the input device, steps of changing orientation of the input device to a first state; determining information about touch position in response to a user's touch; determining information about orientation change between the first state and a default state; wherein, the information about the touch position and the information about orientation change are used to determine the position information in the 3D coordinates system.

According to another aspect of present invention, there is provided an apparatus for providing position information in a 3D coordinates system based on user's touch position on the apparatus. It comprises a first module for receiving a touch position when orientation of the apparatus is changed to be at a first state; a second module for determining information about orientation change between the first state and a default state; wherein, the received touch position and the determined information about orientation change between the first state and the default state being used to determine the position information in the 3D coordinates system.

According to the embodiment, the states correspond to a different tilting of the input device. The touch position on the device provides 2D coordinates, while tilting determines the mapping of these 2D coordinates in a 3D coordinate system.

According to the aspect of present invention, it enables user to use to a single touch screen or touchpad to input 3D coordinates.

It is to be understood that more aspects and advantages of the invention will be found in the following detailed description of the present invention.

### BRIEF DESCRIPTION OF THE DRAWINGS

The accompanying drawings, which are included to provide a further understanding of the present invention, illustrate embodiments of the invention together with the description which serves to explain the principle of the invention. Therefore, the invention is not limited to the embodiments. In the drawings:

FIG. 1 is a diagram showing a system for enabling 3D input according to an embodiment of present invention;

FIG. 2A is a diagram showing a front view and a side view (i.e. view 1 and view 2) of a gravity sensor according to the embodiment of present invention;

FIG. 2B is a diagram showing details of working principle of the gravity sensor according to the embodiment of present invention; and

FIG. 3 is a flow chart showing a method for providing 3D input according to the embodiment of present invention.

### DETAILED DESCRIPTION

An embodiment of the present invention will now be described in detail in conjunction with the drawings. In the following description, some detailed descriptions of known functions and configurations may be omitted for clarity and conciseness. The present invention aims to enable 3D input by using a single touchpad or touch screen.

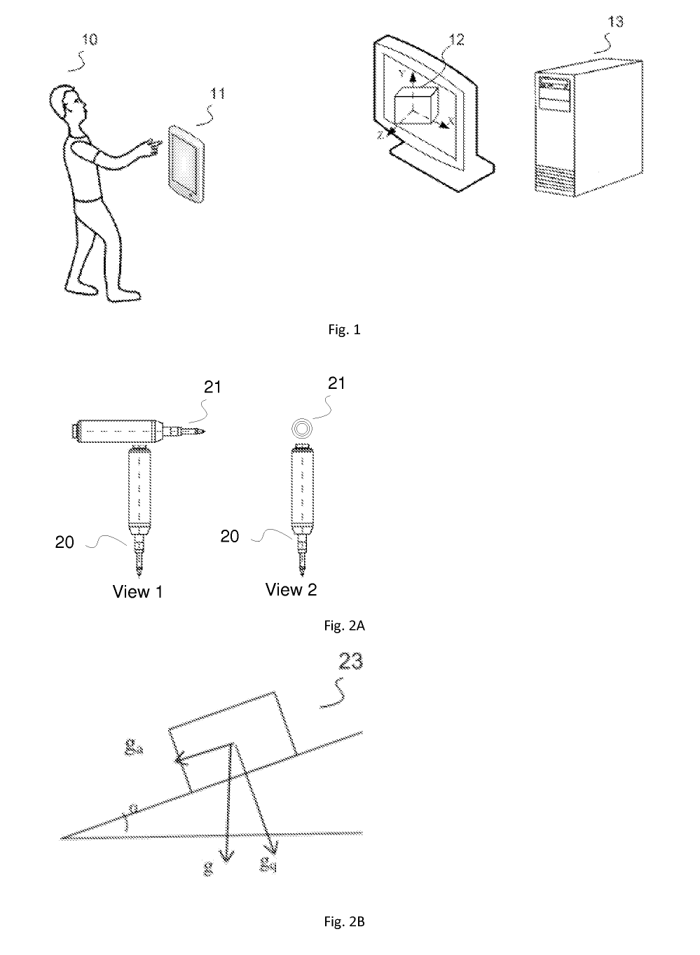

FIG. 1 is a diagram showing a system for enabling 3D input according to an embodiment of present invention. In the system, it comprises a user 10, an input device 11, a display device 12 and a processing device 13.
The input device 11 is equipped with a tactile sensor or other kinds of sensors for detecting touch position and/or movement of the user's finger on the input surface of the input device, and a sensor, such as gravity sensor, accelerometer, etc., for detecting orientation change of the input device 11. Herein, from the viewpoint of the input device 11, the movement can be considered as a sequence of successive touches while maintaining the contact with the input device 11. In this sense, the processing for the movement by the input device is a sum of processing for each touch. For example, the input device 11 is a touchpad with a gravity sensor. More specifically, the gravity sensor is dual-axis tilt sensor as shown in the FIG. 2A, which can measure the tilting in two axes of a reference plane in two axes. In an example, the reference plane is a plane parallel to the surface plane of the display device in 3D coordinates system of actual world (hereinafter referred to as actual 3D coordinates system). As shown in the 2A, two sensor components 20 and 21 are orthogonally placed. Its working principle is to measure the amount of static acceleration due to gravity and find out an angle the device is tilted at relative to the earth's surface. So it can obtain the tilt angle of the input device 11 relative to the horizontal plane or the vertical plane. FIG. 2B shows details of its working principle. The gravity sensor can translate the movement or gravity to electrical voltage. When the gravity sensor is placed in horizontal position, the output voltage is V₀; when it is tilted to an angle of α, the output voltage is V_{α}; when the acceleration of the gravity sensor is g, the output voltage is V. Because of g_{α}=g sinα, the tilt angle relative to the horizontal plane α is α=arcsin[(V_{α}−V₀)/V]. With tilt angles determined before and after the input device 11 is tilted, we can determine the orientation change. As we set a reference plane in this example, the orientation change here is represented by change in angle, i.e. tilt angle of the input device 11 relative to the reference plane.
The display device 12 is used to display objects and/or graphics based on the data outputted by processing device 13.
The processing device 13 is used to:
1) maintain a 3D coordinates system;
2) receive information about position and/or movement of the user's finger and information about orientation change, and translate the position and/or movement in actual 3D coordinates system to a relative position and/or a relative movement in the 3D coordinates system used by the processing device 13 (hereinafter referred to as virtual 3D coordinates system); and
3) output data reflecting the position and/or movement of the user's finger based on the relative position and/or the relative movement in the virtual 3D coordinates system to the display device 12.

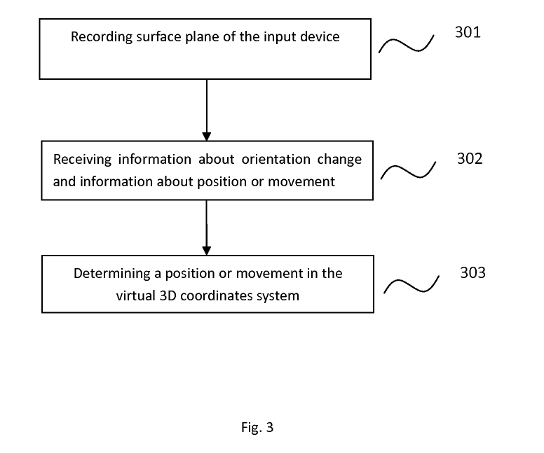

FIG. 3 is a flow chart illustrating a method for providing 3D input according to the embodiment of present invention.

In the step 301, the processing device 13 records current tilt state of the surface plane of the input device 11 as an initial tilt state in a 1^{st} state. Normally, this step is performed before the user makes the 3D input. In an example, the purpose of recording the initial tilt state of the input device 11 is for calculating the orientation change (i.e. angle change in this example) after the input device 11 is tilted. In a variant of the embodiment, the initial tilt state of the input device 11 is preconfigured as being the vertical plane or the horizontal plane in the actual 3D coordinates system. In this case, there is no need to perform this step.

In the step 302, the processing device 13 receives from the input device 11 information about orientation change and information about position or movement of a touching object on the input device 11 once the user has tilted the input device 11 to another state (referred to as a 2^{nd} state) and then touches or moves on it in the actual 3D coordinates system.

In the step 303, the processing device 13 determines a position or movement in the virtual 3D coordinates system, which is used by the processing device 13 for displaying 3D objects on the display device 12, based on the information about orientation change and information about position or movement of the touching object on the input device 11 in the actual 3D coordinates system.

In addition, the user can tilt the input device 11 to another state (referred to as 3^{rd} state) different from the 2^{nd} state and then touch or move on it in the actual 3D coordinates system. The processing device 13 will determine another position or movement in the virtual 3D coordinates system.

In the present embodiment, the processing device 13 provides output in response to the touch and movement in a real-time manner. So the display of the 3D object(s) provides a real-time response to the touch and movement. In a variant of the present embodiment, the processing device 13 provides output after the user finishes the operation of touch or movement in a certain state. In another variant, in order to get an input with x-axis component, y-axis component and z-axis component, the processing device 13 provides output after getting user's inputs in 2 successive states. For example, the determined position or movement in the 2^{nd} state and determined position or movement in the 3^{rd} state are combined together before the processing device 13 communicates the data reflecting the touch or movement in the 2^{nd} state and 3^{rd} state to the displaying device 12.

In another variant of present embodiment, if the processing device needs to get user's inputs in two or more successive states before providing the output, the user is required to keep contact with the input device 11 between making touches or movements during his operation in the two or more successive states. In case of above example that needs inputs in 2 states, after touching or moving in the 2^{nd} state, instead of releasing contact, the user tilts the input device 11 and moves on it with his finger continuously in contact with it.

A concrete example is described below. The vertical plane of the actual 3D coordinates system is preconfigured as reference plane, and corresponds to the X-Y plane in the virtual 3D coordinates system (X axis is horizontal and Y axis is vertical). In an example, the X-Y plane in the virtual 3D coordinates system is the plane of the display screen for displaying 3D objects. The user first places the input device 11 into a vertical position and moves his finger on it, which is translated to input components in X and/or Y axes in the virtual 3D coordinates system. The user keeps his finger on the input device 11, tilts it to a horizontal position and moves his finger on it, which is translated to input components in Z axis and X axis. It shall note the movement on the input device 11 when the input device 11 is tilted to state between the vertical and horizontal can generate input components in X, Y and Z axes. In a variant, the input device 11 is configured to discard some input component, e.g. discarding the X-axis input component when the user moves his finger on the input device 11 being horizontally placed.

According to a variant of the present embodiment, the input device 11 has its own processing units, and the function of determining position or movement in the virtual 3D coordinates system is performed by the input device 11. According to a variant of present embodiment, functions of the input device 11, the display device 12 and the processing device 13 are integrated into a single device, e.g. tablet, mobile phone with touch screen and sensor for detecting orientation change.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1-12. (canceled)

13. A method for providing position information in a 3D coordinates system based on touch position of a touching object on an input device, comprising, at the input device,
changing orientation of the input device to a first state;
detecting at least one touch of the touching object on the input device;
determining position information in the 3D coordinates system based on touch position of the at least one touch and orientation change between the first state and a default state;
changing orientation of the input device from the first state to a second state while maintaining contact of the touching object with the input device;
detecting a movement of the touching object on the input device, wherein the movement comprises a sequence of touches;
determining position information in the 3D coordinates system based on touch positions of the sequence of touches of the movement and orientation change between the second state and the default state; and
providing final position information in the 3D coordinates system based on the determined position information in the first state and the determined position information in the second state.

14. The method according to the claim 13, wherein the at least one touch is a movement of the touching object on the input device, comprising
in response to user's movement on the input device comprising a sequence of touches while keeping contact with the input device, determining position information in the 3D coordinates system based on the sequence of touches and orientation change between the first state and the default state.

15. The method of claim 14 wherein the default state is a state preconfigured for calculating the orientation when changing the orientation of the input device, a state before changing the orientation to the first state, or a state being that the plane of the input device is parallel or orthogonal to the display plane of a display device.

16. The method of claim 14, wherein the orientation change is a change of tilt angle, the method further comprises
determining at least one component value of X, Y and Z axes of the 3D coordinates system for each touch position on the input device based on the touch positions and the change of tilt angle.

17. An apparatus for providing position information in a 3D coordinates system based on a touch position of a touching object on the apparatus, comprising
a first module for detecting at least one touch of the touching object on the apparatus after orientation of the apparatus is changed to be at a first state; and
a second module for determining orientation change between the first state and a default state; and
a processing module for determining position information in the 3D coordinates system based on touch position of the at least one touch and the orientation change between the first state and the default state;
wherein,
after changing orientation of the input device from the first state to a second state while maintaining contact of the touching object with the input device,
the first module further for detecting a movement of the touching object on the input device, wherein the movement comprises a sequence of touches;
the second module further for determining orientation change between the second state and the default state;
the processing module further for determining position information in the 3D coordinates system based on touch positions of the sequence of touches of the movement and orientation change between the second state and the default state; and providing final position information in the 3D coordinates system based on the determined position information in the first state and the determined position information in the second state.

18. The apparatus of the claim 17, wherein the at least one touch is a movement of the touching object on the input device,
the processing module is further used for determining position information in the 3D coordinates system based on the sequence of touches and orientation change between the first state and the default state.

19. The apparatus of the claim 17, further comprising
a display module for displaying at least one 3D object in the 3D coordinates system, wherein, the determined final position information in the 3D coordinates system causes change in the display of the at least one 3D object.

20. The apparatus according to claim 17, wherein, the apparatus is a device with a planar touch screen or touch pad.
